(19) United States
(12) Patent Application Publication
(10) Pub. No.: US 2020/0268212 A1
(43) Pub. Date: Aug. 27, 2020

(54) One-step Production process to produce a multi-layer plastic cutting board

(71) Applicant: Ru Yong LIN, Taizhou (CN)

(72) Inventor: Ru Yong LIN, Taizhou (CN)

(21) Appl. No.: 16/287,375

(22) Filed: Feb. 27, 2019

(51) Int. Cl. A47J 47/00; B32B 33/00; B32B 3/30; B32B 7/022; B32B 7/08; B32B 23/04

(52) U.S. Cl. CPC A47J 47/005; B32B 33/00; B32B 3/30; B32B 7/022; B32B 7/08; B32B 2509/00; B32B 2274/00; B32B 2250/04; B32B 2307/40; B32B 2307/536; B32B 2307/744; B32B 23/04

(57) ABSTRACT

A manufacturing process to produce a multi-layer plastic cutting board incorporating a decorative pattern and non-skid feature by a single manufacturing process, wherein the light weight plastic cutting board has different layers comprising a cutting face, a decal film, a reinforcement layer and a non-skid face are manufactured by a single process, wherein the manufacturer and designer can decide the layer combinations from two layers, three layers to as much as four layers by the controlling in production, wherein all layers are bonded together with permanent joint and rigid for everyday usage.

### TECHNICAL FIELD OF THE INVENTION

The present invention relates to the injection molding and plastic extrusion process of manufacturing multi-layered cutting boards.

### BACKGROUND OF THE INVENTION

Conventional non-skid cutting board manufacturing process is a slow and costly process. Making cutting boards with decal patterns on the top face is also slow and costly. Making non-skid cutting boards with decal pattern is even slower and more costly.

In traditional plastic cutting board manufacturing, the anti-skid part of cutting board is mostly with a rubber-like material like rubber, silicone or thermo-plastic elastomer (TPE) that being attached onto the bottom or the whole circumference of main board by co-molding or overmolding or physically assemble by friction fit or fix by glue. The main cutting board body is primarily made of polypropylene or polyethylene material. After co-molding the non-skid feature, the main board was raised on top of countertop and the non-skid feet contacts with countertop and perform the anti-skid feature by the material's high coefficient of friction.

To manufacture these non-skid cutting boards would request two or more sets of injection molding for the main body and anti-skid feet. This can only be done one part by one part. Production time is long as the anti-skid part have to be co-molded or overmolded or assembly after the main body was made.

Moreover, the shape of the anti-skid part was limited too, with a very small surface area which may not provide enough friction leading to a failure of the anti-skid function. After raising the cutting board above the countertop by anti-skid feet would leave space between bottom of cutting board and the countertop. Water and fruit juice may leak into the space underneath. Once cutting the fruit or food on top face, there will be downward forces applied and squeeze the underneath water or juice out as the plastic board is flexible. This will make the food preparation work messy.

Under current production method limitation, to add pattern onto plastic cutting board surface can only be achieved by in-mold labelling technique, which is like sticking a thin decal onto the cutting board top surface during injection process. The end product is thus not cut resistant, when cutting along back and forth on the decal, it will leave cut mark and the decal will went off eventually time by time.

The new manufacturing process can improve the above weakness of current cutting boards by the multi-layer feature.

By the new ways of production, there is variety of designs and structure combinations can be chosen according to designer's need. One step production can also shorten production time and lower manufacturing costs.

### SUMMARY OF INVENTION

A one-step production process to produce multi-layer plastic cutting boards by a new tailor-made extrusion machine set up. Combinations from two layers, three layers or as much as four layers of structures are feasible and can be freely chosen according to individual need. Layers options:

### 1. Top Cutting Layer:

Preferred to be Polypropylene or Polyethylene material which is light weight and with medium hardness to prevent damaging the knife blade, although other materials like ABS, SAN, Tritan can also be considered. It would be preferred to be semi-translucent color (natural color of polypropylene material) so the underneath decal pattern can be easily seen. It is also feasible not to apply the decal layer so the top layer's color can be semi-translucent or solid color. Direct contact with blade to prevent damage of underneath decal. There is no limitation on the layer thickness, but if the layer is too thick, the decal underneath cannot be seen easily.

### 2. Decal Layer:

A thin decal film, thickness from 0.018-0.04 mm, polypropylene material. As much as 7-color printing, adding the individual design according to individual designer's need can make the cutting board more unique and attractive.

### 3. Reinforcement Layer:

A thicker layer to provide necessary support to the cutting board to perform its function. It would be in the same material as the top layer but there is no limit in color option which can be semi-translucent or solid color despite the color of top layer. This layer provides necessary strength to the cutting board.

If the decal layer is not applied, the reinforcement layer can be directly bonded with the top layer and bottom anti-skid layer.

If both the decal layer and bottom anti-skid layer are not applied, the reinforcement layer can be bonded with the top layer and form a dual-layer cutting board. This would be no anti-skid function but the two-tone color can be used for distinguishing cutting different types of food. For example, the top layer for fruit and bottom layer for bread. There is no limitation on the thickness of this layer.

### 4. Bottom Anti-Skid Layer:

A rubber-like thin layer of thermo-plastic elastomer (TPE) material co-molded with the reinforcement layer to provide anti-skid function by the material feature of high coefficient of friction. The color can be natural semi-translucent or solid color. On the surface, there can be different surface texture or with tailor-made pattern applied to further increase the friction.

If the decal layer and reinforcement layer are not applied, the anti-skid layer can directly bond with the top layer and form a dual layer anti-skid cutting board. There is no limitation on the layer thickness.

### BRIEF DESCRIPTION OF THE DRAWINGS

Implementations of the inventive concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 is a schematic diagram of a multi-layered cutting board, comprising a top cutting layer, a decal layer, a reinforcement layer, and a bottom anti-skid layer.

FIG. 2 is a schematic diagram of a layer construction.

FIG. 3 is a schematic diagram of the production process of the multi-layered cutting board.

FIG. 4 is a schematic diagram of the production process of the multi-layered cutting board.

FIG. 4 is a schematic diagram of injecting process.

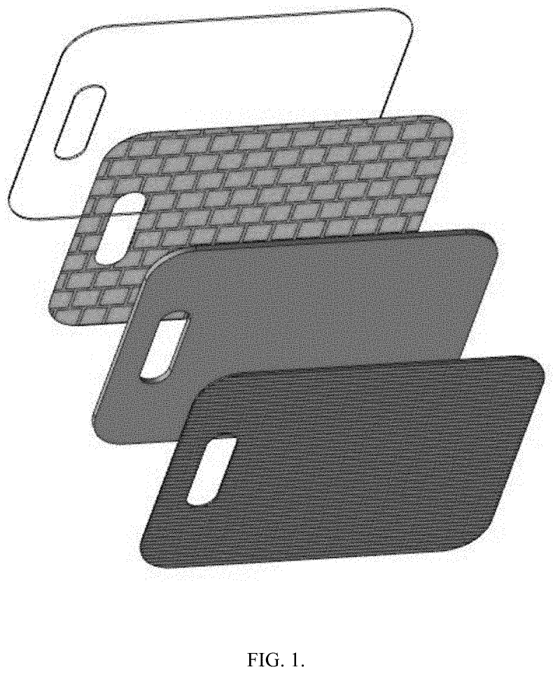

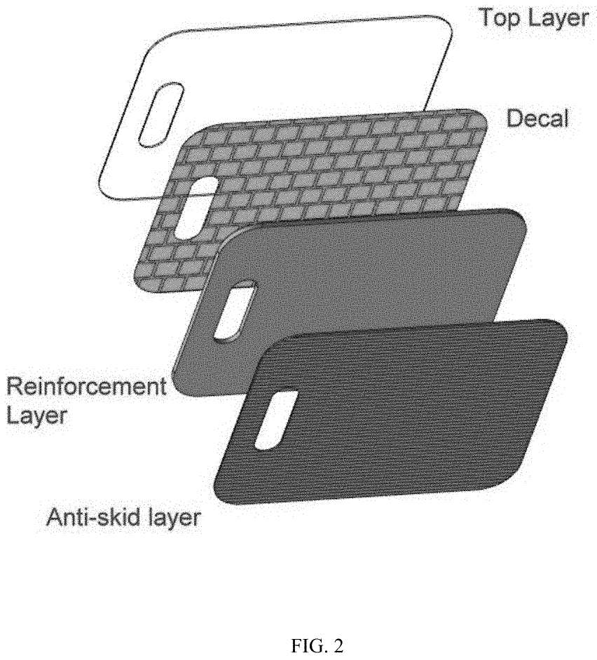

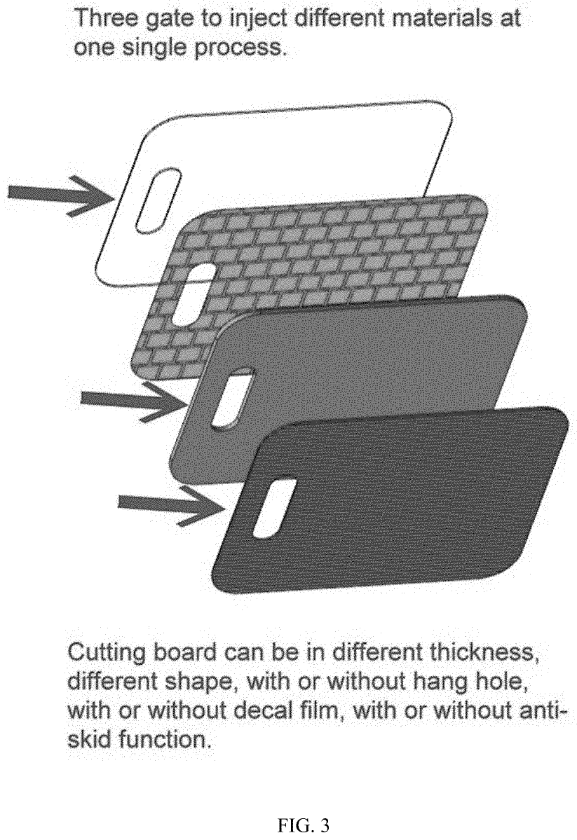

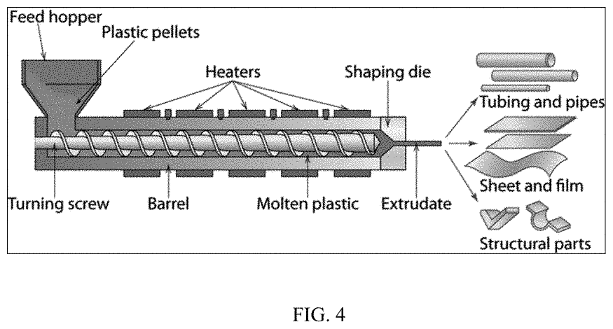

### DETAILED DESCRIPTION

Top Cutting Layer 2 can be comprised of Polypropylene or Polyethylene, which is light weight and with medium hardness to prevent damaging the knife blade, although other materials like ABS, SAN, Tritan can also be considered. It would be preferred to be semi-translucent color (natural color of polypropylene material) so the underneath decal pattern can be easily seen. It is also feasible not to apply the decal layer so the top layer's 2 color can be semi-translucent or solid color. Direct contact with blade to prevent damage of underneath decal. There is no limitation on the layer thickness, but if the layer is too thick, the decal underneath cannot be seen easily.

Decal Layer 3 comprises a thin decal film, thickness from 0.018-0.04 mm, polypropylene material. As much as 7-color printing, adding the individual design according to individual designer's need can make the cutting board more unique and attractive.

Reinforcement layer 4 comprises a thicker layer to provide necessary support to the cutting board to perform its function. It would be in the same material as the top layer 2 but there is no limit in color option which can be semi-translucent or solid color despite the color of top layer 2. This layer provides necessary strength to the cutting board.

If the decal layer is not applied, the reinforcement layer can be directly bonded with the top layer and bottom anti-skid layer 5.

If both the decal layer 3 and bottom anti-skid layer 5 are not applied, the reinforcement layer can be bonded with the top layer and form a dual-layer cutting board. This would be no anti-skid function but the two-tone color can be used for distinguishing cutting different types of food. For example, the top layer 2 for fruit and bottom layer 5 for bread. There is no limitation on the thickness of this layer.

Bottom anti-skid layer 5 can be a rubber-like thin layer of thermo-plastic elastomer (TPE) material co-molded with the reinforcement layer to provide anti-skid function by the material feature of high coefficient of friction. The color can be natural semi-translucent or solid color. On the surface, there can be different surface texture or with tailor-made pattern applied to further increase the friction.

If the decal layer 3 and reinforcement layer 4 are not applied, the anti-skid layer 5 can directly bond with the top layer 2 and form a dual layer anti-skid cutting board. There is no limitation on the layer thickness.

### Manufacturing Process

The poly layer cutting board is mainly a combination of plastic extrusion of thin plastic sheet and computer numerical control (CNC) machine milling process.

First, thermoplastic pellets are fed into the barrel of the extrusion machine. Color agents can be added if the end product were colorized. The thermoplastic pellets are melted under the high heat from the barrel and compressed by the turning screw inside the barrel, then squeezed out through a shaping die and passed in between two rollers, one at top and one at bottom forming thin sheet. At this stage, the plastic sheet is still hot and soft.

By the designer's need, there are as many as three barrels set up at three different levels extruding three different sheets of thermosetting plastics at the same time. From top to bottom: top cutting layer, reinforcement layer and anti-skid layer. Each layer comes from different barrel, and thus can be made with different color and different materials.

The sheets of thermoplastics are still hot and soft, can be two or three depends on designer's need, will be further compressed through a second set of rollers to from the multi-layer end product. As the plastic is still hot, the molecular bonds are still weak so after the second rolling and cooling, the bond will then be permanent. If there is a need to from different surface texture or special pattern at top and bottom, the texture can be applied on the second rollers so after compression, texture or pattern will be left on end product surfaces.

The decal film can be applied underneath the top later, just before the second rolling. After the second rolling, a multi-layer sheet in designated thickness will be formed and the current machine set up were limited to 800 mm width. The final product thickness was controlled by the distance between the roller bars. After second rolling, the multi-layer sheet will be sliced into designated length according to final product size. There will be pieces of rectangular sheets ready for the CNC machine milling process.

The whole process from melting the plastic pellet to multi-layer sheet is around 10-15 mins. Once the multi-barrel extrusion machine was set up, production is continuous.

The second production process aiming to cut and mill the multi-layer sheet into final product by a CNC machine. Metal blades will cut the multi-layer sheet into designated shape (rectangle, square, round, ellipse, triangle and any irregular shape). Miller blade will take out unnecessary plastic inside the cutting board forming the hollow handle and juice groove.

After the CNC process, dust and impurities will be removed before packaging into final product.

In the tradition way of manufacturing multi-layer cutting board 1, there would be one material injected to one mold cavity at one time. In the case, producer would request to finish each layer one time in one machine. First layer in one cavity, take it out and transfer to another cavity for second shot. This can be achieved by two injection molding machines, each with single barrel, and two sets of injection molds. Or by use of one dual-shot injection machine with two barrels and one set of specially designed injection mold for production.

The main difference of the new manufacturing process is: for current process, there is time sequence between each layer which need to be finished one by one. By use of the new process and new machinery, with use of as much as three barrels, shooting different materials or same material with different colors at the same time producing multi-layer cutting boards in a single step of production.

In addition, for the in-mold label decal, in the tradition way due to limitation of in-mold label technique, the decal was first placed on either side of the mold cavity before shooting melted plastic. Thus, the decal was limited to appear at the top cutting surface only, which is not cut-resistant.

By the new invented process, the decal was covered by the semi-translucent top layer which provide adequate protection to the decal by hiding the decal underneath preventing the direct contact with knife.

There is no limit on the shape of multi-layer cutting board due to the usage of CNC machine, it can be rectangular, square, round, ellipse, triangular or other shape like with an extended handle. There is no limit on the thickness of cutting board also. In addition, according to individual design need, there can be hang hole on the board as shown in reference drawing or one complete flat surface is also feasible.

It is an object of the present invention to provide a cutting board with a complete layer of anti-skid base 5 to perform the maximum limitation of slip when cutting to enable safer kitchen environment.

Another object of the present invention is to provide a cut-resistance decal cutting board which adding fun to cooking and increase the design flexibility for designers.

Another object of the present invention is to provide flexible manufacturing and material option to fit with individual market need. Combination of two, three or as much as four layers with different material and color choices of each layer are available due to the new way of production.

Another object of the present invention is to make manufacturing fast and cost saving way to produce multi-layer cutting boards by the one-step production.

Another object of the present invention is to provide a non-skid cutting board with a complete flat non-skid base with no gap between the cutting board and countertop. This will be prohibiting any liquid or juice to flow underneath and spilt out when cutting. Food preparation is neater and tidier.

1. A method to produce a multi-layer plastic cutting board by a new tailor-made injection machine set-up in one step, comprising:
laying down a top layer; setting a decal layer beneath the top layer;
laying a reinforcement layer beneath the decal layer;
adding a bottom anti-skid layer beneath the reinforcement layer, wherein during the multi-layer extrusion process, wherein at least two barrels are utilized to disperse material into thin sheets simultaneously, as opposed to sequentially, thereby producing a multi-layer cutting board in one single step.

2. The method of claim 1, wherein the decal of the decal layer is covered by a semi-translucent top layer, which provides adequate protection to the decal from direct contact with a knife.

3. The method of claim 1, wherein the multi-layered cutting board can be any shape, color, or thickness.

4. The method of claim 1, wherein a complete flat non-skid base with no gap is disposed between the cutting board and countertop to prohibit any liquid or juice to flow underneath and spilt out when cutting

5. The method of claim 1, wherein with respect to the bottom anti-skin layer, a rubber-like thin layer of thermo-plastic elastomer (TPE) material co-molded with the reinforcement layer provides anti-skid function by the material feature of high coefficient of friction.

6. The method of claim 5, wherein the color of the anti-skid layer can be natural semi-translucent or solid color, and wherein the surface can comprise different textures or patterns applied to further increase the friction.

7. The method of claim 1, wherein with respect to the reinforcement layer, a thicker layer is used to provide necessary support to the cutting board having the same material as the top layer, but which could be any color.

8. The method of claim 1, wherein the decal layer has a thickness from 0.018-0.04 mm of a polypropylene material.

9. The method of claim 1, wherein the top cutting layer is comprised of a variety of materials, including Polypropylene, Polyethylene, ABS, SAN, or Tritan.

10. The method of claim 9, wherein the top cutting layer is semi-translucent so the underneath decal pattern within the decal layer can be easily seen.

11. The method of claim 1, wherein the cutting board is provided with an inclined upper cutting surface, and one or more drainage apertures extend through the board adjacent at a lower end of the inclined cutting surface.

12. The method of claim 1, wherein the cutting board includes a disposable container which captures juices, gravy and scraps produced during the carving operation.

13. The method of claim 1, wherein a handle is affixed to the top layer, which makes it convenient to carry.

14. The method of claim 1, wherein the handle can be angled upward at about 30 degrees from said cutting surface.

15. The method of claim 1, wherein a juice channel is indented in the cutting surface and spaced from and parallel to three sides of the body top cutting layer.

16. The method of claim 1, wherein the cutting board has medial and peripheral drain holes to remove the juices, drippings, and food trimmings produced during the preparation of foods.

17. The method of claim 1, wherein a trough traverses the periphery of the cutting board to ensure complete drainage of the fluids from the cutting surface.

18. The method of claim 1, wherein the cutting board can be stably suspended over a sink which comprises four substantially rigid legs attached to a planar surface.
